(19) United States
(12) Patent Application Publication
(10) Pub. No.: US 2018/0206004 A1
(43) Pub. Date: Jul. 19, 2018

(54) ENHANCED RESTART TV

(71) Applicant: Telefonaktiebolaget LM Ericsson (publ), Stockholm (SE)

(72) Inventors: Donald Joong, Montreal (CA); Ganish Katyal, Oakville (CA)

(21) Appl. No.: 15/742,655

(22) PCT Filed: Jul. 9, 2015
(86) PCT No.: PCT/IB2015/055203

§ 371 Date: Jan. 8, 2018

(51) Int. Cl. H04N 21/81; H04N 21/845; H04N 21/472; H04N 21/2187

(52) U.S. Cl. CPC H04N 21/812; H04N 21/2187; H04N 21/47202; H04N 21/8456

(57) ABSTRACT

Systems and methods are disclosed herein for providing an enhanced Restart Television (TV) service. In some embodiments, a playout device receives a restart TV request for a linear TV content item, where the restart TV request is a request to restart playout of the linear TV content item in an enhanced playout mode of operation. The playout device is further operable to obtain the linear TV content item from a server system, obtain metadata for enhanced playout of the linear TV content item where the metadata defines required playout segments of the linear TV content item, and provide enhanced playout of the linear TV content item. Enhanced playout includes starting playout at a beginning of the linear TV content item and automatically beginning fast-forwarding playout to a first required playout segment defined by the metadata.

### TECHNICAL FIELD

The present disclosure relates to Internet Protocol Television (IPTV) and, in particular, to Restart Television (TV).

### BACKGROUND

Internet Protocol Television (IPTV) services are delivered using the architecture and methods of the Internet Protocol (IP) suite over a packet-switched network infrastructure, e.g., the Internet and broadband Internet access networks, instead of being delivered through traditional radio frequency broadcast, satellite signal, or Cable Television (CATV) formats. Linear Television (TV) or scheduled content TV is a TV service where the viewer has to watch a scheduled TV program at a particular time at which it is offered and on a particular channel on which it is presented. Commercial linear TV typically includes advertisements, or commercials, embedded within and in between TV programs.

Time shift TV is a popular service that allows the viewer to pause, rewind, fast-forward, or resume a linear TV program while it is being broadcasted. Fast-forward is possible up to the point in time when the recorded stream being played becomes identical to what is being broadcasted live. The capture of time shift content is either done on the local client equipment (which is referred to herein as a playout device) or in the network.

Restart TV is a specific implementation of time shift TV that enables a viewer to watch a linear TV program that is already in progress from the beginning of that linear TV program. The restart TV feature is particularly useful if, e.g., the viewer missed the scheduled start time of the linear TV program or forgot to schedule recording of the liner TV program on his or her Personal Video Recorder (PVR). Restart TV is especially popular for sporting events when a viewer has missed the start of a sporting event.

Because Restart TV is a popular feature among viewers, service providers are looking for ways for further enhance Restart TV to further differentiate their services from those of their competitors.

### SUMMARY

Systems and methods are disclosed herein for providing an enhanced Restart Television (TV) service. In some embodiments, a playout device enabled to provide an enhanced Restart TV feature for playout of a linear TV content item from a TV service provider is operable to receive a restart TV request for a linear TV content item, the restart TV request being a request to restart playout of the linear TV content item in an enhanced playout mode of operation. The playout device is further operable to obtain the linear TV content item from a server system, obtain metadata for enhanced playout of the linear TV content item where the metadata defines required playout segments of the linear TV content item. The playout device is further operable to provide enhanced playout of the linear TV content item. In order to provide the enhanced playout of the linear TV content item, the playout device is operable to start playout of the linear TV content item at a beginning of the linear TV content item and automatically begin fast-forwarding playout of the linear TV content item to a first required playout segment of the linear TV content item defined by the metadata. In some embodiments, the enhanced Restart TV service enables a viewer to “catch-up” to live broadcast of the linear TV content item without missing any required segments (e.g., highlights and, in some embodiments, commercials).

In some embodiments, the required playout segments comprise highlight segments of the linear TV content item. Further, in some embodiments, the highlight segments of the linear TV content item are content owner or operator defined. Further, in some embodiments, the required playout segments comprise commercial segments of the linear TV content item.

In some embodiments, in order to provide the enhanced playout of the linear TV content item, the playout device is further operable to determine that the automatic fast-forwarding has reached the first required playout segment of the linear TV content item and, upon determining that the automatic fast-forwarding has reached the first required playout segment of the linear TV content item, provide playout of the first required playout segment of the linear TV content item at normal playout speed. Further, in some embodiments, in order to provide the enhanced playout of the linear TV content item, the playout device is further operable to, upon completion of the playout of the first required playout segment, automatically begin fast-forwarding playout of the linear TV content item to a next required playout segment of the linear TV content item defined by the metadata.

In some embodiments, in order to provide the enhanced playout of the linear TV content item, the playout device is further operable to determine that the automatic fast-forwarding has reached a next required playout segment of the linear TV content item, provide playout of the next required playout segment of the linear TV content item at normal playout speed upon determining that the automatic fast-forwarding has reached the next required playout segment of the linear TV content item, and repeat, for one or more subsequent required playout segments, the process of: (a) upon completion of the playout of the next required playout segment, automatically begin fast-forwarding playout of the linear TV content item to a new next required playout segment of the linear TV content item of the plurality of required playout segments of the linear TV content item defined by the metadata; (b) determine that the automatic fast-forwarding has reached the new next required playout segment of the linear TV content item; and (c) upon determining that the automatic fast-forwarding has reached the new next required playout segment of the linear TV content item, provide playout of the new next required playout segment of the linear TV content item at normal playout speed.

In some embodiments, in order to provide the enhanced playout of the linear TV content item, the playout device is further operable to, while automatically fast-forwarding playout of the linear TV content item from one of the required playout segments to a next one of the required playout segments, determine that the automatic fast-forwarding of the playout of the linear TV content item has reached live playout of the linear TV content item, and end enhanced playout of the linear TV content item upon determining that the automatic fast-forwarding of the playout of the linear TV content item has reached live playout of the linear TV content item.

In some embodiments, in order to provide the enhanced playout of the linear TV content item, the playout device is further operable to, while automatically fast-forwarding playout of the linear TV content item from one of the required playout segments to a next one of the required playout segments, receive a trick-play request, and process the trick-play request upon receiving the trick-play request. Further, in some embodiments, the trick-play request is one of a group consisting of: a play request, a pause request, and a rewind request. Further, in some embodiments, in order to provide the enhanced playout of the linear TV content item, the playout device is further operable to, upon detecting a trigger to resume enhanced playout, automatically begin fast-forwarding the linear TV content item to a next required playout segment of the linear TV content item defined by the metadata.

In some embodiments, in order to provide the enhanced playout of the linear TV content item, the playout device is further operable to determine that a request to jump to a specified required playout segment has been received, and provide playout of the specified required playout segment upon determining that a request to jump to the specified required playout segment has been received. Further, in some embodiments, the specified required playout segment is a next required playout segment. In some other embodiments, the specified required playout segment is a preceding required playout segment. In some other embodiments, the specified required playout segment is a required playout segment other than a next required playout segment and a preceding required playout segment.

Embodiments of a method of operation of a playout device are also disclosed.

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example system in which an enhanced Restart Television (TV) feature is provided according to some embodiments of the present disclosure;

FIGS. 2A and 2B illustrate the operation of the server system and the playout device of FIG. 1 to provide an enhanced Restart TV feature according to some embodiments of the present disclosure;

FIG. 3 is a flow chart that illustrates a process for enhanced playout of a linear TV content item for enhanced Restart TV according to some embodiments of the present disclosure;

FIGS. 4 and 5 are block diagrams of the playout device according to some embodiments of the present disclosure; and

FIGS. 6 and 7 are block diagram of an example server computer included in the server system according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Before describing embodiments of the present disclosure, it is beneficial to define a number of terms.
Linear Television (TV): As used herein, linear TV is a TV service where the viewer has to watch a scheduled TV content item (referred to herein as a linear TV content item) at the particular time that it is offered and on the particular channel on which it is presented.
Restart TV: As used herein, Restart TV is a feature, or service, provided with respect to linear TV by which a viewer is enabled to restart playout of a linear TV content item from the beginning of that linear TV content item even if, e.g., the viewer missed the scheduled start time of the linear TV content item or forgot to set recording on his or her Personal Video Recorder (PVR).
Linear TV Content Item: As used herein, a linear TV content item is a TV program (e.g., a sporting event, the news, a movie, a TV show, or the like) provided via a linear TV service (i.e., a service that provides linear TV). In some embodiments, the linear TV content item includes both primary content (i.e., the Audio/Video (A/V) content for, e.g., the sporting event, the news, the movie, the TV show, or the like desired to be viewed by the end-user) and commercial content (i.e., commercials) inserted between segments of the primary content of the linear TV content item. In other embodiments, the linear TV content item includes only the primary content. In these embodiments, commercial content may, in some embodiments, be obtained and inserted between segments of the primary content of the linear TV content item.
Highlight Segment: As used herein, a highlight segment is a segment of the primary content of a linear TV content item.
Commercial Segment: As used herein, a commercial segment is a segment of commercial content included in a linear TV content item. In some embodiments, a commercial segment is included in the linear TV content item in advance. In other embodiments, a commercial segment is a segment that is inserted into the linear TV content item during playout of the linear TV content item (e.g., during enhanced playout for an enhanced Restart TV feature).

Conventional Restart TV enables a viewer, or user, to select the Restart TV feature for an eligible linear TV content item. In response, playout of the linear TV content item goes back to the beginning of the linear TV content item. In some circumstances, it is acceptable to the user to then start watching the linear TV content item from the beginning and continue its normal consumption with the corresponding delay relative to the real-time broadcast. However, in other circumstances, the user would like to catch-up with the real-time broadcast. For instance, if the linear TV content item is a sporting event, the user may desire to catch-up with the real-time, or live, broadcast of the sporting event. However, this is not possible or is at least difficult to do using conventional Restart TV.

Specifically, trick-play features (e.g., rewind, pause, and fast-forward) are typically disabled during playout, or replay, of Restart TV content. This is typically due to business or contractual agreements between the service provider/network operator and the content provider/owner. For instance, the service provider/network operator may be obligated to replay the Restart TV content in its entirety even with commercials. Further, even if trick-play features are enabled during playout of Restart TV content such that the user can fast-forward through the Restart TV content to view only desired content (e.g., scoring events such as touchdowns during a football game or goals or penalty shots during a hockey game, a knock down during a boxing match, or the like) in order to catch-up with the real-time broadcast, it is difficult for the user to do so because the user is not aware of when the desired content will occur.

Systems and methods are disclosed herein for providing an enhanced Restart TV service that overcome the aforementioned deficiencies of conventional Restart TV services. As discussed below, in some embodiments, the enhanced Restart TV service enables an enhanced playout mode for Restart TV in which playout automatically fast-forwards from one required playout segment of the linear TV content item to the next required playout segment of the linear TV content item. The required playout segments include, in some embodiments, highlight segments (e.g., scoring events during a sporting event) and, in some embodiments, commercial, or advertisement, segments. By including commercial segments as required playout segments, any mandatory playout of commercials associated with the linear TV content item need not be compromised (i.e., commercials can be shown and the viewer cannot skip over the commercials). In some embodiments, the required playout segments are defined by the content provider or content owner of the linear TV content item or defined by the TV service provider (which may also be referred to herein as the network operator). In this manner, the content owner/provider or the service provider maintains control of which segments the user is required to view while at the same time the user is enabled to catch-up with the live, or real-time, broadcast of the linear TV content item.

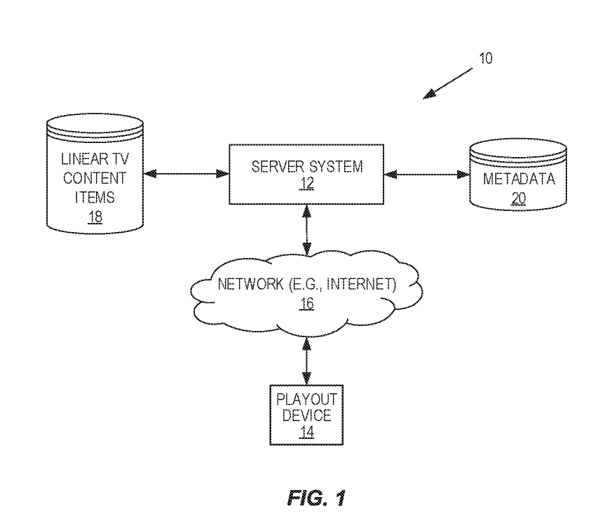

FIG. 1 illustrates a system 10 in which an enhanced Restart TV service is provided according to some embodiments of the present disclosure. As illustrated, the system 10 includes a server system 12 and a playout device 14, or client device/equipment, communicatively coupled via a network 16 (e.g., the Internet, a proprietary network of a TV service provider, or a combination thereof). While not illustrated, the server system 12 includes one or more server computers, which may be co-located or geographically distributed and connected over a network (e.g., the network 16). The server system 12 may, for example, include one or more server computers operated by a TV service provider.

The server system 12 has access to linear TV content items 18 and metadata 20 for enhanced playout of the linear TV content items 18 for the enhanced Restart TV service. Notably, in some cases, the linear TV content items 18 may be only the portion of the linear TV content items 18 up to the live, or real-time, broadcast. For instance, for a live sporting event, the stored linear TV content item 18 for that sporting event may be updated in real-time to include the recorded sporting event up to the live, or real-time, broadcast. Conversely, if the linear TV content item 18 is a pre-recorded program (e.g., a movie or TV show), the linear TV content item 18 may be the entire pre-recorded program.

The metadata 20 generally includes, for each linear TV content item 18 for which the enhanced Restart TV service is enabled, data that defines required playout segments for that linear TV content item 18. Notably, not all linear TV content items may eligible for enhanced Restart TV. In some embodiments, the linear TV content items 18 that are eligible for enhanced Restart TV are identified by the content owner/provider. In some embodiments, the linear TV content items 18 include only those linear TV content items 18 for which enhanced Restart TV is enabled.

For a particular linear TV content item 18, the required playout segments are generally segments that the user will be required/forced to watch in normal playout speed. In some embodiments, the required playout segments include highlight segments and, potentially, commercial segments. The required segments are preferably defined by the owner/provider of the content or the TV service provider. In some embodiments, the metadata 20 for a linear TV content item 18 includes, for each required playout segment, a text description of the required playout segment (e.g., for end-user presentation), a time offset from the beginning of the linear TV content item 18 (e.g., 5 minutes from the start), and a duration of the required playout segment. Notably, for playout of a required segment, playout may begin at normal speed at the offset defined by the metadata 20 or a predefined amount of time (e.g., 10 or 15 seconds) before the offset, depending on the particular implementation.

The playout device 14 is generally any device capable of playout of enhanced Restart TV content from the linear TV service provider. The playout device 14 may present the enhanced Restart TV content via a display and speakers incorporated into the playout device 14 (e.g., the playout device 14 may be a TV) or may present the enhanced Restart TV content via an external display and speakers (e.g., the playout device 14 may be a set-top box or similar device that connects to a A/V system via A/V cable(s) (e.g., a High Definition Multimedia Interface (HDMI) cable)). Some examples of the playout device 14 are, but are not limited to, a set-top box provided by a TV service provider, a smart TV, an Apple TV, a Roku device, an Amazon TV device, or the like. Notably, the playout device 14 can be, e.g., any device that supports IPTV natively or through a (custom) application built for the device/platform. For example, the playout device 14 may be a smart TV where the enhanced Restart TV feature is provided via a custom application built for and running on the smart TV.

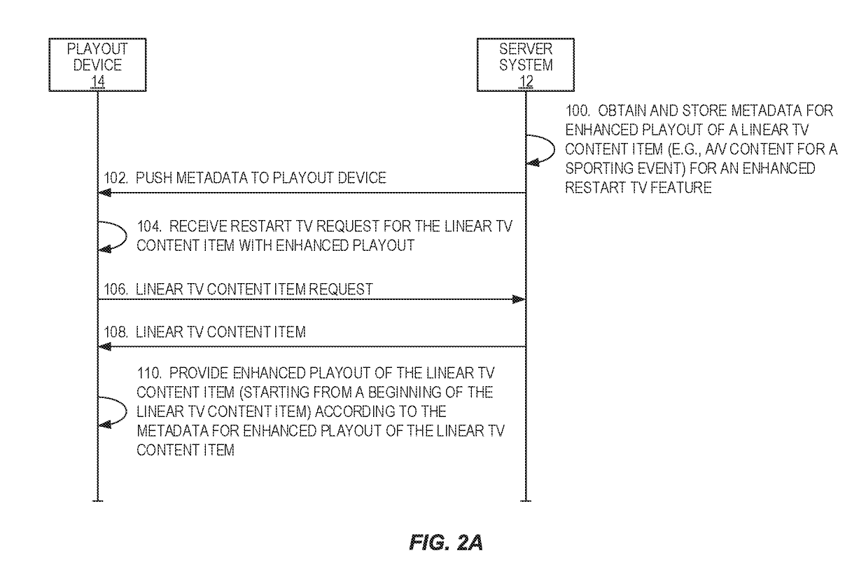

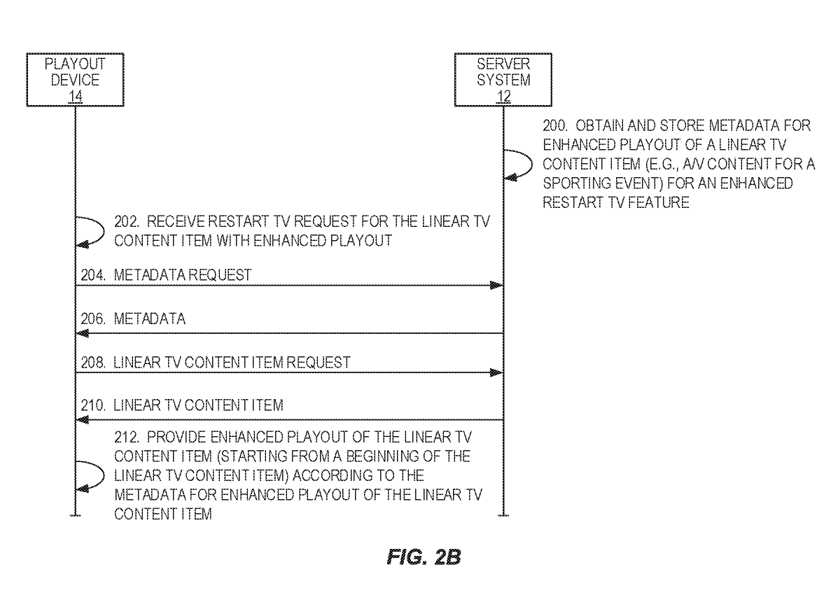

FIGS. 2A and 2B illustrate the operation of the server system 12 and the playout device 14 to provide an enhanced Restart TV feature according to some embodiments of the present disclosure. The embodiments of FIGS. 2A and 2B are similar, but differ in how/when the metadata 20 is obtained by the playout device 14. As illustrated in FIG. 2A, the server system 12 obtains and stores the metadata 20 for enhanced playout of a linear TV content item(s) 18 for the enhanced Restart TV feature (step 100). This metadata 20 may be obtained from, e.g., the owner/provider of the linear TV content item 18 or the service provider/network operator. For example, for a live event (e.g., a live sporting event), the content owner/provider may define and update the metadata 20 in real-time during the live event. As discussed above, the metadata 20 defines multiple required playout segments of the linear TV content item 18.

In this embodiment, the server system 12 pushes the metadata 20 to the playout device 14 (step 102). For example, in some embodiments, the metadata 20 is pushed to the Internet Protocol TV Terminal Function (ITF) as part of extended Electronic Programming Guide (EPG) data (for the corresponding linear TV content item(s) 18). Note that the server system 12 may, in some embodiments, include a dedicated Third Party Product (3PP) server that is deployed to maintain/update the metadata 20 in real-time for linear TV content times 18 for which the enhanced Restart TV feature is provided.

The playout device 14 receives a Restart TV request for the linear TV content item 18 with enhanced playout (step 104). For example, a user of the playout device 14 may request Restart TV for the linear TV content item 18. In doing so, either via the same request or via an option associated with the request, the user requests enhanced playout. In some embodiments, the user may be given the option for enhanced playout and may, in his or her discretion, choose whether enhanced playout or normal playout is to be provided. Upon receiving the Restart TV request with enhanced playout, the playout device 14 requests the linear TV content item 18 from the server system 12 (step 106). In response, the server system 12 provides the linear TV content item 18 to the playout device 14 (step 108). For example, the server system 12 may begin streaming the linear TV content item 18 to the playout device 14.

The playout device 14 provides enhanced playout of the linear TV content item 18, starting from the beginning of the linear TV content item 18, according to the metadata 20 for enhanced playout of the linear TV content item 18 (step 110). More specifically, as discussed below, the playout device 14 automatically fast-forwards playout of the linear TV content item 18 from one required playout segment to the next required playout segment until playout catches up with the live, or real-time, broadcast. Notably, in some cases, the viewer may never catch-up (e.g., if the user begins Restart TV playout near the end of the live broadcast). The content rendered by the playout device 14 during fast-forwarding is dependent on the streaming technology being used. For instance, during fast-forwarding, the playout device 14 may render a chronological ordering of still frames from the linear TV content item 18 or may render the actual linear TV content item 18 in accelerated playout. As fast-forwarding consumption approaches a required playout segment, the playout device 14 automatically returns to normal speed playout of the linear TV content item 18 such that playout of the required playout segment is provided at normal playout speed. In some embodiments, normal playout begins at the offset identified in the metadata 20. In other embodiments, a cueing period may be added such that playout of the required playout segment beings at a predefined cueing period (e.g., 10 or 15 seconds) prior to the offset identified in the metadata 20.

FIG. 2B illustrates a process that is substantially the same as that in FIG. 2A but where the playout device 14 requests the metadata 20 from the server system 12 according to some other embodiments of the present disclosure. As illustrated in FIG. 2B, the server system 12 obtains and stores the metadata 20 for enhanced playout of a linear TV content item(s) 18 for the enhanced Restart TV feature, as discussed above (step 200). In this embodiment, the playout device 14 receives a Restart TV request for the linear TV content item 18 with enhanced playout, as discussed above (step 202). Upon receiving the Restart TV request with enhanced playout, the playout device 14 requests the metadata 20 for enhanced playout of the linear TV content item 18 from the server system 12 (step 204). Upon receiving the request, the server system 12 provides the metadata 20 to the playout device 14 (step 206). Note that the server system 12 may, in some embodiments, include a dedicated 3PP server that is deployed to maintain/update the metadata 20 in real-time for linear TV content items 18 for which the enhanced Restart TV feature is provided. Also, while the metadata 20 is obtained from the server system 12 in this embodiment, the present disclosure is not limited thereto. The metadata 20 may alternatively be obtained from an alternative source.

In addition, the playout device 14 requests the linear TV content item 18 from the server system 12 (step 208). In response, the server system 12 provides the linear TV content item 18 to the playout device 14 (step 210). For example, the server system 12 may begin streaming the linear TV content item 18 to the playout device 14. As discussed above, the playout device 14 provides enhanced playout of the linear TV content item 18, starting from the beginning of the linear TV content item 18, according to the metadata 20 for enhanced playout of the linear TV content item 18 (step 212).

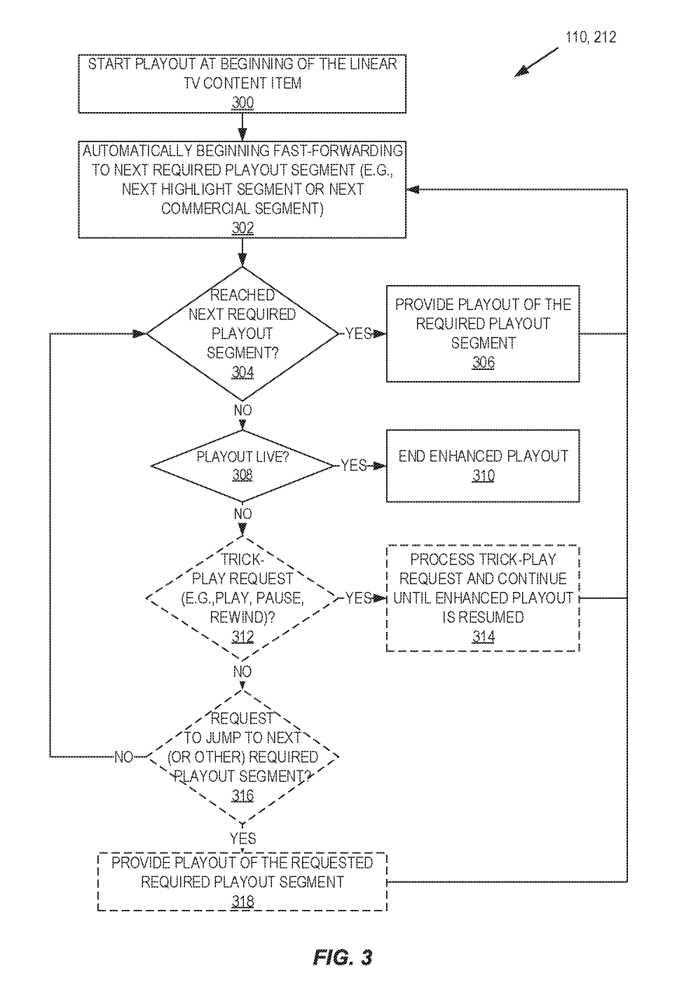

FIG. 3 is a flow chart that illustrates a process for enhanced playout of Restart TV content according to some embodiments of the present disclosure. In particular, FIG. 3 illustrates steps 110 and 212 of FIGS. 2A and 2B, respectively, in more detail according to some embodiments of the present disclosure. Notably, the “steps” illustrated can be performed in any suitable order (i.e., are not limited to being performed in the illustrated order). Further, some of the steps may be performed in parallel.

As illustrated, for enhanced playout of a linear TV content item 18 for the enhanced Restart TV feature, the playout device 14 starts playout of the linear TV content item 18 starting at the beginning of the linear TV content item 18 (step 300). Assuming that the start of the linear TV content item 18 is not a required playout segment or that playout of any initial required playout segment is complete, the playout device 14 automatically begins fast-forwarding of the linear TV content item 18 to a next required playout segment (which for the first iteration is the first required playout segment) (step 302). While fast-forwarding, the playout device 14 determines whether the fast-forwarding has reached the next required playout segment (step 304). In some embodiments, the playout device 14 determines that the next required playout segment is reached when fast-forwarding has reached the identified offset for that segment in the metadata 20 for enhanced playout. In other embodiments, the playout device 14 determines that the next required playout segment is reached when fast-forwarding has reached a predefined cueing period prior to the identified offset for that segment in the metadata 20 for enhanced playout.

Upon determining that the next required playout segment has been reached, the playout device 14 provides playout of that required playout segment (step 306). Here, playout is provided at the normal playout speed. Playout of the required playout segment continues until the end of the required playout segment has been reached. Notably, while not illustrated, if playout reaches a point equivalent to the live, or real-time, broadcast of the linear TV content item 18 before reaching the end of the required segment, enhanced playout ends (i.e., playout switches to the live broadcast of the linear TV content item 18). Note that, in some embodiments, if the required playout segment is a commercial segment, the playout device 14 may obtain (e.g., stream) the commercial content for the commercial segment from a remote source (e.g., the server system 12) and provide playout of the obtained commercial content for the commercial segment. However, as discussed above, in other embodiments, the commercial content for the commercial segment is already embedded into the linear TV content item 18. Once playout of the required playout segment is complete, the process returns to step 302 where the playout device 14 automatically begins fast-forwarding to the next required playout segment (step 302).

Returning to step 304, upon determining that fast-forwarding consumption has not yet reached the next required playout segment, the playout device 14 determines whether fast-forwarding has reached the live playout, or live broadcast, of the linear TV content item 18 (step 308). If so, the playout device 14 ends enhanced playout of the linear TV content item 18 (i.e., playout switches to the live broadcast of the linear TV content item) (step 310). If fast-forwarding has not reached live playout, processing continues. In some embodiments, at this point, processing returns to step 304. However, in the illustrated example, some optional steps, as indicated by dashed lines, may be performed.

As illustrated, while fast-forwarding to the next required playout segment, the playout device 14 may determine whether a trick-play request has been received, e.g., from the user or, more precisely, from an input device (e.g., a remote control) which may be controlled by the user (step 312). The trick-play request may be, e.g., a play request, a pause request, or a rewind request. If a trick-play request has been received, the playout device 14 processes the trick-play request and then continues in an appropriate manner until enhanced playout is resumed (step 314). For example, if a trick-play request is received, the playout device 14 stops fast-forwarding of the linear TV content item 18 and provides playout at the normal speed. This normal playout continues until, e.g., a request to resume enhanced playout is received. This request to resume enhanced playout may be, for example, a fast-forward request or a specific request to resume enhanced playout. In other words, a trick-play request may transition playout from the enhanced playout to normal Restart TV playout where, e.g., trick-play features may be disabled. Once/if enhanced playout is resumed, the process returns to step 302.

As another optional feature, while fast-wording to the next required playout segment (or possibly during playout of a current required playout segment), the playout device 14 determines whether a request to jump to a next (or other) required playout segment has been received (step 316). If such a request has been received, the playout device 14 provides playout of the requested/specified required playout segment (step 318). Upon completion of playout of the requested/specified required playout segment, the process returns to step 302. In this example, if no such request has been received (step 316; NO), the process returns to step 304.

Some examples will help illustrate some possible variations for steps 316 and 318. As a first example, during fast-forwarding, the playout device 14 may receive a request to jump to the next required playout segment. In response, the playout device 14 may immediately jump to the next playout segment without further fast-forwarding. As a second example, during playout of a current required playout segment, the playout device 14 may receive a request to jump to the next required playout segment. In response, the playout device 14 may continue playout of the current required playout segment until playout of the current required playout segment is complete and then jump to the next required playout segment without fast-forwarding. As a third example, during fast-forwarding or during playout of a current playout segment, the playout device 14 may receive a request to jump to playout of the preceding required playout segment or some earlier required playout segment and then jump to the requested playout segment (e.g., immediately). Further, text based descriptions of the segments (e.g., from the metadata 20) may be presented to the user to assist the user in selecting a desired segment to view. In some embodiments, steps 316 and 318 enable the user to toggle between different required playout segments.

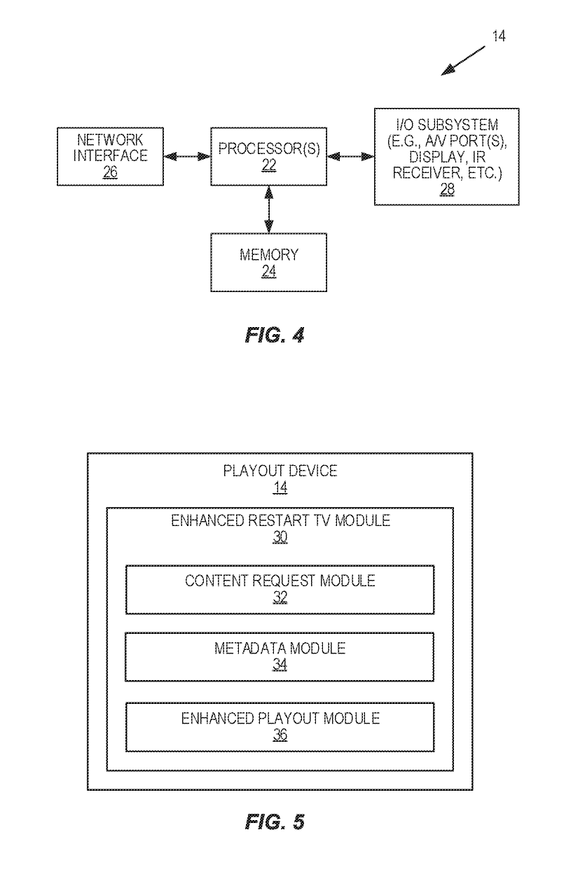

FIGS. 4 and 5 illustrate some example embodiments of the playout device 14. As illustrated in FIG. 4, in some embodiments, the playout device 14 includes one or more processors 22 (e.g., one or more Central Processing Units (CPUs), one or more Application Specific Integrated Circuits (ASICs), one or more Field Programmable Gate Arrays (FPGAs), or the like), memory 24, a network interface 26, and an Input/Output (I/O) subsystem 28. The network interface 26 may be a wired or wireless interface (e.g., a Network Interface Card (NIC) or adaptor) that enables the playout device 14 to connect to the network 16. The I/O subsystem 28 may include components such as, for example, Audio/Video (A/V) port(s) (e.g., a HDMI port), a display, an Intra-Red (IR) receiver enabling input from a remote control, or the like. The details of the I/O subsystem 28 will depend on the particular implementation of the playout device 14. In some embodiments, the functionality of the playout device 14 described herein is implemented in software that is stored in the memory 24 and is executable by the processor(s) 22.

As illustrated in FIG. 5, in some other embodiments, the playout device 14 includes an enhanced Restart TV module 30, which is implemented in software. The enhanced Restart TV module 30 receives a Restart TV request for enhanced playout of a linear TV content item 18. In response, the enhanced Restart TV module 30 provides enhanced playout of the linear TV content item 18 as described above. In this example, the enhanced Restart TV module 30 includes a content request module 32, a metadata module 34, and an enhanced playout module 36. The content request module 32 operates to request and receive the desired linear TV content item 18 for an enhanced Restart TV request. The metadata module 34 operates to obtain the metadata 20 for enhanced playout, as described above. The enhanced playout module 36 provides enhanced playout of the desired linear TV content item 18 according to the metadata 20 for enhanced playout, as described above.

In some embodiments, a computer program including instructions which, when executed by at least one processor, causes the at least one processor to carry out the functionality of the playout device 14 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 24).

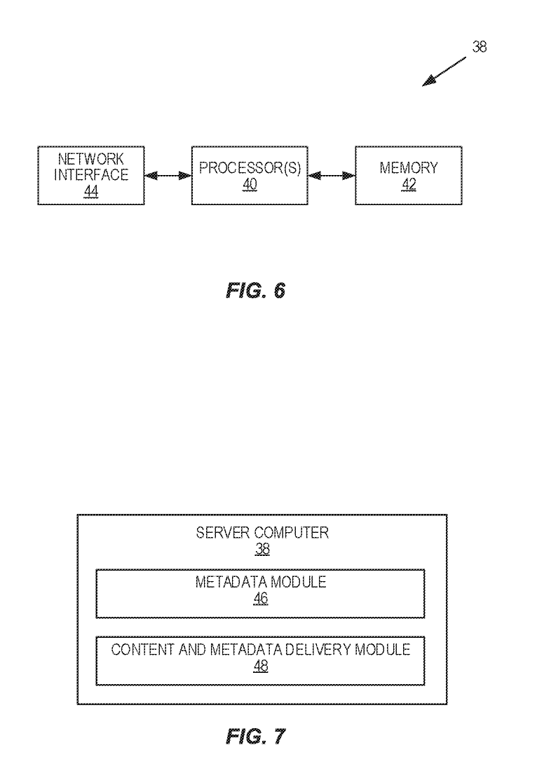

FIGS. 6 and 7 illustrate some example embodiments of a server computer 38, which may be included in the server system 12 according to some embodiments of the present disclosure. As illustrated in FIG. 6, in some embodiments, the server computer 38 includes one or more processors 40 (e.g., one or more CPUs, one or more ASICs, one or more FPGAs, or the like), memory 42, and a network interface 44. The network interface 44 may be a wired or wireless interface (e.g., a NIC or adaptor) that enables the server computer 38 to connect to the network 16. In some embodiments, at least some of the functionality of the server system 12 described herein is implemented in software that is stored in the memory 42 and is executable by the processor(s) 40.

As illustrated in FIG. 7, in some other embodiments, the server computer 38 includes a metadata module 46 and a content and metadata delivery module 48, which are implemented in software. The metadata module 46 operates to obtain and store the metadata 20 for enhanced playout of the linear TV content items 18, as discussed above. The content and metadata delivery module 48 operates to provide the linear TV content items 18 and the corresponding metadata 20 for enhanced playout to playout devices, such as the playout device 14, as described above.

In some embodiments, a computer program including instructions which, when executed by at least one processor, causes the at least one processor to carry out at least some, but potentially all, of the functionality of the server system 12 according to any of the embodiments described herein is provided. In some embodiments, a carrier containing the aforementioned computer program product is provided. The carrier is one of an electronic signal, an optical signal, a radio signal, or a computer readable storage medium (e.g., a non-transitory computer readable medium such as the memory 42).

The following acronyms are used throughout this disclosure.
3PP Third Party Product
ASIC Application Specific Integrated Circuit
A/V Audio/Video
CATV Cable Television
CPU Central Processing Unit
EPG Electronic Programming Guide
FPGA Field Programmable Gate Array
HDMI High Definition Multimedia Interface
I/O Input/Output
IP Internet Protocol
IPTV Internet Protocol Television
IR Intra-Red
ITF Internet Protocol Television Terminal Function
NIC Network Interface Card
PVR Personal Video Recorder
TV Television

Those skilled in the art will recognize improvements and modifications to the embodiments of the present disclosure. All such improvements and modifications are considered within the scope of the concepts disclosed herein and the claims that follow.

1. A playout device enabled to provide an enhanced restart Television, TV, feature for playout of a linear TV content item from a TV service provider, comprising:
a network interface operable to communicatively couple the playout device to a network;
at least one processor; and
memory containing instructions executable by the at least one processor whereby the playout device is operable to:
receive a restart TV request for a linear TV content item, the restart TV request being a request to restart playout of the linear TV content item in an enhanced playout mode of operation;
obtain the linear TV content item from a server system via the network interface;
obtain metadata for enhanced playout of the linear TV content item, the metadata defining a plurality of required playout segments of the linear TV content item; and
provide enhanced playout of the linear TV content item, wherein, in order to provide the enhanced playout of the linear TV content item, the playout device is operable to start playout of the linear TV content item at a beginning of the linear TV content item and automatically begin fast-forwarding playout of the linear TV content item to a first required playout segment of the linear TV content item of the plurality of required playout segments of the linear TV content item defined by the metadata.

2. The playout device of claim 1 wherein the plurality of required playout segments comprise a plurality of highlight segments of the linear TV content item.

3. The playout device of claim 2 wherein the plurality of highlight segments of the linear TV content item are content owner or operator defined.

4. The playout device of claim 1 wherein the plurality of required playout segments comprise a plurality of commercial segments of the linear TV content item.

5. The playout device of claim 1 wherein, in order to provide the enhanced playout of the linear TV content item, the playout device is further operable to:
determine that the automatic fast-forwarding has reached the first required playout segment of the linear TV content item; and
upon determining that the automatic fast-forwarding has reached the first required playout segment of the linear TV content item, provide playout of the first required playout segment of the linear TV content item at normal playout speed.

6. The playout device of claim 5 wherein, in order to provide the enhanced playout of the linear TV content item, the playout device is further operable to:
upon completion of the playout of the first required playout segment, automatically begin fast-forwarding playout of the linear TV content item to a next required playout segment of the linear TV content item of the plurality of required playout segments of the linear TV content item defined by the metadata

7. The playout device of claim 5 wherein, in order to provide the enhanced playout of the linear TV content item, the playout device is further operable to:
determine that the automatic fast-forwarding has reached a next required playout segment of the linear TV content item;
upon determining that the automatic fast-forwarding has reached the first required playout segment of the linear TV content item, provide playout of the next required playout segment of the linear TV content item at normal playout speed; and
repeat, for one or more subsequent required playout segments of the plurality of required playout segments, the process of: (a) upon completion of the playout of the next required playout segment, automatically begin fast-forwarding playout of the linear TV content item to a new next required playout segment of the linear TV content item of the plurality of required playout segments of the linear TV content item defined by the metadata; (b) determine that the automatic fast-forwarding has reached the new next required playout segment of the linear TV content item; and (c) upon determining that the automatic fast-forwarding has reached the new next required playout segment of the linear TV content item, provide playout of the new next required playout segment of the linear TV content item at normal playout speed.

8. The playout device of claim 1 wherein, in order to provide the enhanced playout of the linear TV content item , the playout device is further operable to:
while automatically fast-forwarding playout of the linear TV content item from one of the plurality of required playout segments to a next one of the plurality of required playout segments, determine that the automatic fast-forwarding of the playout of the linear TV content item has reached live playout of the linear TV content item; and
upon determining that the automatic fast-forwarding of the playout of the linear TV content item has reached live playout of the linear TV content item, end enhanced playout of the linear TV content item.

9. The playout device of claim 1 wherein, in order to provide the enhanced playout of the linear TV content item, the playout device is further operable to:
while automatically fast-forwarding playout of the linear TV content item from one of the plurality of required playout segments to a next one of the plurality of required playout segments, receive a trick-play request; and
upon receiving the trick-play request, process the trick-play request.

10. The playout device of claim 9 wherein the trick-play request is one of a group consisting of: a play request, a pause request, and a rewind request.

11. The playout device of claim 9 wherein, in order to provide the enhanced playout of the linear TV content item, the playout device is further operable to:
upon detecting a trigger to resume enhanced playout, automatically begin fast-forwarding the linear TV content item to a next required playout segment of the linear TV content item of the plurality of required playout segments of the linear TV content item defined by the metadata.

12. The playout device of claim 1 wherein, in order to provide the enhanced playout of the linear TV content item, the playout device is further operable to:
determine that a request to jump to a specified required playout segment has been received; and
upon determining that a request to jump to the specified required playout segment has been received, provide playout of the specified required playout segment.

13. The playout device of claim 12 wherein the specified required playout segment is a next required playout segment.

14. The playout device of claim 12 wherein the specified required playout segment is a preceding required playout segment.

15. The playout device of claim 12 wherein the specified required playout segment is a required playout segment other than a next required playout segment and a preceding required playout segment.

16. A method of operation of a playout device enabled to provide an enhanced restart Television, TV, feature for playout of a linear TV content item from a TV service provider, comprising:
receiving a restart TV request for a linear TV content item, the restart TV request being a request to restart playout of the linear TV content item in an enhanced playout mode of operation;
obtaining the linear TV content item from a server system;
obtaining metadata for enhanced playout of the linear TV content item, the metadata defining a plurality of required playout segments of the linear TV content item; and
providing enhanced playout of the linear TV content item, wherein providing the enhanced playout of the linear TV content item comprises:
starting playout of the linear TV content item at a beginning of the linear TV content item; and
automatically beginning fast-forwarding playout of the linear TV content item to a first required playout segment of the linear TV content item of the plurality of required playout segments of the linear TV content item defined by the metadata.

17-19. (canceled)

20. A playout device enabled to provide an enhanced restart Television, TV, feature for playout of a linear TV content item from a TV service provider, the playout device comprising:
means for receiving a restart TV request for a linear TV content item, the restart TV request being a request to restart playout of the linear TV content item in an enhanced playout mode of operation;
means for obtaining the linear TV content item from a server system;
means for obtaining metadata for enhanced playout of the linear TV content item, the metadata defining a plurality of required playout segments of the linear TV content item; and
means for providing enhanced playout of the linear TV content item, wherein the means for providing the enhanced playout of the linear TV content item is configured to start playout of the linear TV content item at a beginning of the linear TV content item and automatically begin fast-forwarding playout of the linear TV content item to a first required playout segment of the linear TV content item of the plurality of required playout segments of the linear TV content item defined by the metadata.

21. (canceled)
